(19) United States
(12) Patent Application Publication
(10) Pub. No.: US 2024/0381996 A1
(43) Pub. Date: Nov. 21, 2024

(54) CONNECTOR FOR A FURNITURE FRAME, FURNITURE FRAME, AND FURNITURE

(71) Applicant: AICCI OY, Muurame (FI)

(72) Inventors: Sauli Koukkari, Vaajakoski (FI); Päivi CHARPENTIER, Helsinki (FI)

(21) Appl. No.: 17/790,772

(22) PCT Filed: Jan. 8, 2021
(86) PCT No.: PCT/FI2021/050010

§ 371 Date: Jul. 5, 2022

(30) Foreign Application Priority Data
Jan. 10, 2020 (FI) 20205025

(51) Int. Cl. A47B 13/02; F16B 12/50; F21V 8/00

(52) U.S. Cl. CPC A47B 13/021; F16B 12/50; G02B 6/0091; A47B 2220/0077

(57) ABSTRACT

This disclosure relates to a connector, a furniture frame (800), and a piece of furniture, e.g., a table. The furniture frame (800) comprises a first connector (810), a second connector (820), and a frame rail (830) connecting the first connector (810) with the second connector (820). The frame rail (830) comprises a first structural profile (840) and a second structural profile (850) coupled with the first structural profile (840) such that a light guide support groove (860) is formed between the first structural profile (840) and the second structural profile (850)

### FIELD OF TECHNOLOGY

This disclosure concerns furniture. In particular, this disclosure concerns illuminating furniture and structures therefor.

### BACKGROUND

Selection of aesthetically pleasing and practical furniture as well as functional lighting design are key elements in interior architecture.

In conventional solutions, furniture is selected to provide sufficient facilities for any intended activities, and lighting is separately provided to ensure suitable illumination for said activities.

However, especially in case of strict space constraints, providing sufficient levels of high-quality illumination may be challenging. Using conventional solutions, arranging light sources in a manner that results in minimal obstruction for passage as well as simple electrical wiring arrangements may also prove demanding.

In light of this, it may be desirable to develop new solutions related to illuminating furniture. Such solutions may preferably be based on structures that are durable and easy to manufacture and repair.

### SUMMARY

This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to a first aspect, a connector for a furniture frame for a piece of furniture, e.g., a table, is provided. The connector comprises a junction part; a first rail mount coupled with the junction part; a second rail mount coupled with the junction part; and a tubular leg mounting insert configured to be inserted into a hollow furniture leg, the leg mounting insert having a proximal end towards the junction part and a distal end opposite the proximal end and comprising a side wall, extending from the junction part to the distal end. A wiring pathway extends from the distal end to the proximal end within the leg mounting insert and from the proximal end further to each of the first rail mount and the second rail mount within the junction part.

According to a second aspect, a furniture frame for a piece of furniture, e.g., a table, is provided. The furniture frame comprises a first connector, a second connector, and a frame rail connecting the first connector with the second connector. The first connector and/or the second connector is a connector in accordance with the first aspect or any embodiment thereof.

According to a third aspect, a piece of furniture, e.g., a table, is provided. The piece of furniture comprises a furniture frame in accordance with the second aspect or any embodiment thereof.

According to a fourth aspect, a furniture frame for a piece of furniture, e.g., a table, is provided. The furniture frame comprises a first connector, a second connector, and a frame rail connecting the first connector with the second connector. The frame rail comprises a first structural profile and a second structural profile coupled with the first structural profile such that a light guide support groove is formed between the first structural profile and the second structural profile.

In an embodiment of the fourth aspect, the first structural profile comprises a first sheet part and a second sheet part, extending from and at an angle with respect to the first sheet part, and the second structural profile comprises a fastening groove configured to supportingly receive the first sheet part such that the light guide support groove is formed between the second sheet part and the second structural profile.

In an embodiment of the fourth aspect, which may or may not be in accordance with the preceding embodiment, the second structural profile has a first mounting end as well as a second mounting end and comprises a tubular hole, e.g., a slot or a through-hole, extending from the first mounting end and/or the second mounting end, the tubular hole being configured to receive a pin fastener.

In an embodiment of the fourth aspect, which may or may not be in accordance with any of the preceding embodiments, the first structural profile and/or the second structural profile comprises aluminum.

In an embodiment of the fourth aspect, which may or may not be in accordance with any of the preceding embodiments, the second structural profile comprises a tubular stiffener duct between the first mounting end and the second mounting end and a tubular reinforcement rod fixed in the stiffener duct.

In an embodiment of the fourth aspect in accordance with the preceding embodiment, the reinforcement rod comprises steel.

In an embodiment of the fourth aspect, which may or may not be in accordance with any of the preceding embodiments, the first connector and/or the second connector is a connector in accordance with the first aspect or any embodiment thereof.

According to a fifth aspect, a piece of furniture, e.g., a table, is provided. The piece of furniture comprises a furniture frame in accordance with the fourth aspect or any embodiment thereof.

In an embodiment of the fifth aspect, the piece of furniture comprises a light source, e.g., a light-emitting diode (LED) source, coupled to the furniture frame.

In an embodiment of the fifth aspect, which may or may not be in accordance with the preceding embodiment, the piece of furniture comprises a light guide plate supported by the furniture frame and arranged such that light emitted by the light source is directed into the light guide plate through an edge face thereof.

### BRIEF DESCRIPTION OF THE DRAWINGS

The present disclosure will be better understood from the following Detailed Description read in light of the accompanying drawings, wherein:

FIG. 1 shows a connector for a furniture frame according to an embodiment,

FIG. 2 depicts a leg fastening collar for a connector,

FIG. 3 illustrates a cross-sectional view of a frame rail,

FIG. 4 shows a connector for a furniture frame,

FIG. 5 depicts a top view of the connector,

FIG. 6 illustrates a cross-sectional view of the connector along plane VI of FIG. 4,

FIG. 7 shows a cross-sectional view of the connector along plane VII of FIG. 4,

FIG. 8 depicts a furniture frame,

FIG. 9 illustrates a cross-sectional view of the furniture frame along plane IX of FIG. 8, and

FIG. 10 shows a table.

Unless specifically stated to the contrary, any drawing of the aforementioned drawings may be not drawn to scale such that any element in said drawing may be drawn with inaccurate proportions with respect to other elements in said drawing in order to emphasize certain structural aspects of the embodiment of said drawing.

Moreover, corresponding elements in the embodiments of any two drawings of the aforementioned drawings may be disproportionate to each other in said two drawings in order to emphasize certain structural aspects of the embodiments of said two drawings.

### DETAILED DESCRIPTION

FIG. 1 depicts a connector 100 for a furniture frame for a piece of furniture, e.g., a table, according to an embodiment. In other embodiments, a connector for a furniture frame for a piece of furniture, e.g., a table, may be identical, similar, or different to the connector 100 of the embodiment of FIG. 1.

The connector 100 of the embodiment of FIG. 1 comprises a junction part 110.

Herein, a “junction part” may refer to an element of a connector, wherefrom other elements of said connector extend and/or whereto other elements of said connector may be coupled or connected.

The connector 100 of the embodiment of FIG. 1 comprises a first rail mount 121 and a second rail mount 122.

Throughout this specification, a “rail mount” may refer to a part, an element, or structure of a connector suitable for or configured to be coupled with a frame rail of a furniture frame for a piece of furniture, e.g., a table. Additionally or alternatively, a rail mount may refer to a part, an element, or structure suitable for or configured to hold, bear, and/or support such frame rail.

In the embodiment of FIG. 1, the first rail mount 121 and the second rail mount 122 are configured to be coupled with two mutually perpendicular frame rails. In other embodiments, a first rail mount and a second rail mount may be configured to be coupled with a first and a second frame rail, respectively, wherein said first and said second frame rail may be arranged with any suitable (smallest) angle, e.g., non-zero, at least 10°, at least 20°, or at least 30° and/or less than or equal to 180°, between one another.

The connector 100 of the embodiment of FIG. 1 comprises a tubular leg mounting insert 130.

In this specification, a “leg mounting insert” may refer to a part, an element, or structure of a connector, configured to be inserted into a hollow furniture leg. A leg mounting insert may have a proximal end towards a junction part and a distal end opposite said proximal end. Such distal end may or may not face away from a junction part of a connector. A leg mounting insert may comprise a side wall, extending from such junction part to a distal end of said leg mounting insert.

Further, a “tubular” part, element, or structure may refer to said part, element, or structure having a generally tube-formed shape. Additionally or alternatively, a tubular part, element, or structure may have an elongated shape, with any suitable, e.g., a circular, elliptical, or polygonal, cross-sectional shape, perpendicular to its direction of elongation. Additionally or alternatively, a tubular part, element, or structure may be hollow.

Herein, a “hollow” part, an element, or structure may refer to said part, element, or structure comprising a hole, e.g., a through-hole. Additionally or alternatively, a hollow part, element, or structure may comprise a cavity and/or define or outline an inner space.

The leg mounting insert 130 of the embodiment of FIG. 1 has a proximal end 131 towards the junction part 110 and a distal end 132 opposite the proximal end 131. The leg mounting insert 130 comprises a side wall 133, which extends from the junction part 110 to the distal end 132.

In the embodiment of FIG. 1, a wiring pathway 111 extends within the leg mounting insert 130 from the distal end 132 to the proximal end 131. The wiring pathway 111 extends further, within the junction part 110, from the proximal end 131 to the first rail mount 121 and the second rail mount 122. In other embodiments, a wiring pathway may extend from a distal end to a proximal end within a leg mounting insert and from said proximal end further to each of a first rail mount and a second rail mount within a junction part. Such wiring pathway in a connector for a furniture frame for a piece of furniture, e.g., a table, may facilitate provision of electrical power and/or electrical signals for an electrical component, such as a light source, of such piece of furniture. Additionally or alternatively, such wiring pathway may reduce obstruction for passage caused, for example, by electrical cables and/or simplify electrical wiring arrangements for light sources.

Throughout this specification, a “wiring pathway” may refer to a path suitable for or configured to carry electrical power and/or electrical signals using electrical wiring such as an electrical cable. A wiring pathway may generally comprise, for example, open space suitable for passing an electrical cable therethrough and/or one or more electrical feedthrough connectors.

FIG. 2 shows a leg fastening collar 200 for a connector for a furniture frame for a piece of furniture, e.g., a table. The leg fastening collar 200 comprises a hollow, cylindrical shell 201 with three discontinuous annular snap joint elements 202. The shell 201 further comprises a longitudinal gap 203. The shell 201 is formed of elastic material(s) such that the longitudinal gap 203 may be reversibly broadened by exerting suitable forces on the leg fastening collar 200.

In the embodiment of FIG. 1, the side wall 133 has an outer surface 140. The outer surface 140 comprises a narrowed region 141 for holding a leg fastening collar, which may be, for example, in accordance with the leg fastening collar 200 of FIG. 2. Such narrowed region may simplify attaching a furniture leg to a connector. In particular, a hollow furniture leg may be fixable to a connector by hand without the use of tools by inserting a leg mounting insert of said connector into said furniture leg. Such narrowed region may then help to maintain a leg fastening collar surrounding a narrowed region in place during such insertion. Additionally or alternatively, such narrowed region may facilitate forming a connector couplable with a furniture leg. Additionally or alternatively, such narrowed region may enable coupling a variety of furniture legs to a connector. In other embodiments, an outer surface of a leg mounting insert may or may not comprise such narrowed region.

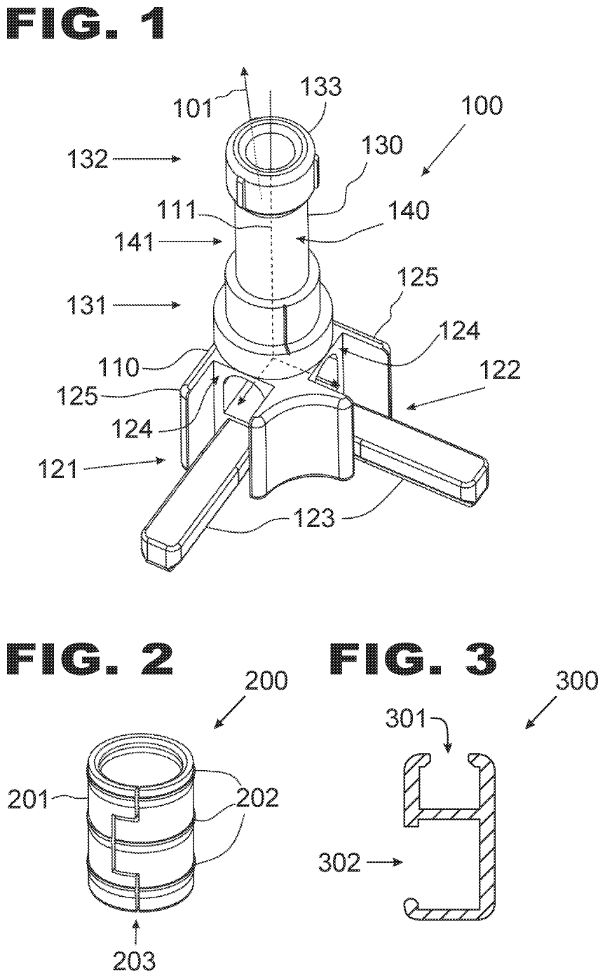

FIG. 3 depicts a cross-sectional view of a frame rail 300. The frame rail 300 comprises a mounting groove 301 and a light guide support groove 302.

In this specification, a “light guide support groove” may refer to a groove suitable for or configured to support a light guide plate. Additionally or alternatively, a light guide support groove may refer to a groove configured to receive an edge face of a light guide plate in order to support said light guide plate. A light guide support groove may generally have any suitable width. A light guide plate may generally have a thickness greater than or equal to 2 millimeters (mm), or 3 mm and/or less than or equal to 30 mm, or 25 mm, or 20 mm. As such, a light guide support groove may have a width greater than or equal to 2 mm, or 3 mm and/or less than or equal to 30 mm, or 25 mm, or 20 mm.

In the embodiment of FIG. 1, each of the first rail mount 121 and the second rail mount 122 comprises a mounting protrusion 123 for supporting a frame rail, which may be, for example, in accordance with the frame rail 300 of FIG. 3. Such mounting protrusion may simplify mounting a frame rail to a connector. In particular, a frame rail, comprising a suitable receptacle, for example, a mounting groove, or recess, or hole, e.g., a through-hole, or the like, may be mounted to a connector by hand without the use of tools by inserting a mounting protrusion of said connector into said receptacle. In other embodiments, a first rail mount and/or a second rail mount of a connector may or may not comprise a mounting protrusion for supporting a frame rail.

In the embodiment of FIG. 1, the connector 100 has an exterior side 101. In FIG. 1, the connector 100 is shown from an interior side thereof such that the exterior side 101 is hidden from view.

Throughout this specification, an “exterior side” of a connector for a furniture frame for a piece of furniture, e.g., a table, may refer to a side thereof facing outwards, when said piece of furniture or said furniture frame is in use. Additionally or alternatively, when a first rail mount and a second rail mount are configured to be coupled with a first and a second frame rail, respectively, said first and said second frame rail being arranged with a smallest angle between one another of less than 180°, an exterior side of a connector may refer to a side of said connector facing away from said smallest angle.

In the embodiment of FIG. 1, each of the first rail mount 121 and the second rail mount 122 comprises a rail end abutment surface 124. In other embodiments, a first rail mount and/or a second rail mount may or may not comprise a rail end abutment surface.

In this disclosure, a “rail end abutment surface” may refer to a surface of a first rail mount or a second rail mount configured to receive and/or abut an end surface of a frame rail, or a part thereof.

In the embodiment of FIG. 1, each of the first rail mount 121 and the second rail mount 122 further comprises a light block protrusion 125, extending from the junction part 110 beyond the rail end abutment surface 124. The light block protrusions 125 are configured to hide the rail end abutment surfaces 124 from view from the exterior side 101, when the connector 100 is in use. Such light block protrusion(s) may reduce leakage of light from an interior side of a connector to an exterior side thereof. In other embodiments, a first rail mount and/or a second rail mount may or may not comprise a rail end abutment surface and a light block protrusion extending from a junction part beyond said rail end abutment surface, said light block protrusion being configured to hide said rail end abutment surface from view from an exterior side of a connector, when said connector is in use.

Herein, a light block protrusion being “configured to hide a rail end abutment surface from view from an exterior side, when a connector is in use” may refer to said light block protrusion being configured to conceal said rail end abutment surface, when a connector is in use in a furniture frame for a piece of furniture, e.g., a table. Additionally or alternatively, a light block protrusion being configured in such manner may refer to said light block protrusion extending on an exterior side of a connector beyond a gap formed between a rail end abutment surface and an end surface of a frame rail, abutting said rail end abutment surface, when said connector is in use.

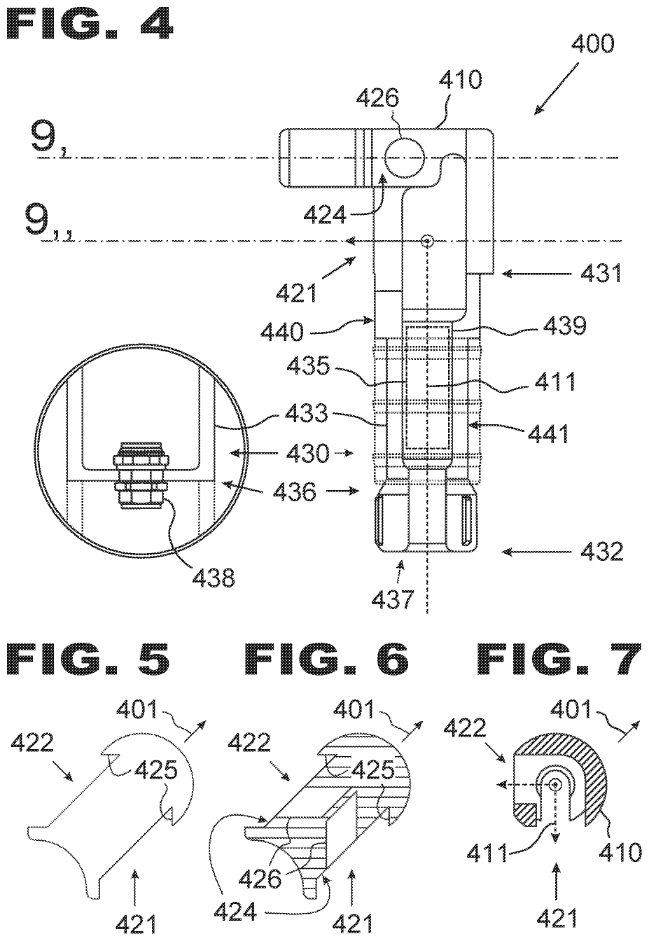

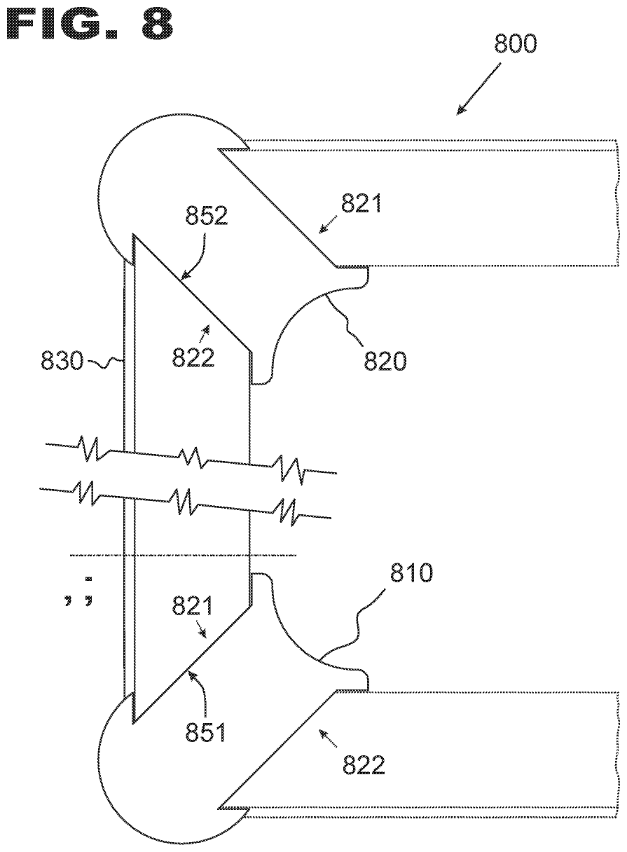

FIG. 4 depicts a connector 400 for a furniture frame for a piece of furniture, e.g., a table, according to an embodiment. FIG. 5 shows a top view of the connector 400 of FIG. 4, whereas FIG. 6 and FIG. 7 illustrate cross-sectional views of the connector 400 along planes VI and VII of FIG. 4, respectively. In other embodiments, a connector for a furniture frame for a piece of furniture, e.g., a table, may be identical, similar, or different to the connector 400 of the embodiment of FIGS. 4 to 7.

In the embodiment of FIGS. 4 to 7, the connector 400 comprises a junction part 410; a first rail mount 421 and a second rail mount 422, both coupled with the junction part 410; and a tubular leg mounting insert 430 configured to be inserted into a hollow furniture leg. The leg mounting insert 430 has its proximal end 431 towards the junction part 410 and its distal end 432 opposite the proximal end 431. The leg mounting insert 430 comprises a side wall 433, extending from the junction part 410 to the distal end 432.

In the embodiment of FIGS. 4 to 7, a wiring pathway 411 extends from the distal end 432 to the proximal end 431 within the leg mounting insert 430. The wiring pathway 411 extends further from the proximal end 431 to each of the first rail mount 421 and the second rail mount 422 within the junction part 410.

In the embodiment of FIGS. 4 to 7, the leg mounting insert 430 comprises a wiring support structure 436 for securing electrical wiring, extending along the wiring pathway 411, to the side wall 433. Such wiring support structure may enable relieving strain in an electrical cable during use of a connector. In other embodiments, a leg mounting insert may or may not comprise such wiring support structure.

The wiring support structure 436 of the embodiment of FIGS. 4 to 7 comprises a connector support extension 437 of the side wall 433, the connector support extension 437 projecting laterally inwards. Such connector support extension may simplify the structure of a connector. Additionally or alternatively, such connector support extension may facilitate and/or quicken arranging an electrical cable such that it is secured to a side wall. In other embodiments, a wiring support structure may or may not comprise such connector support extension.

Herein, a “connector support extension” may refer to part of a side wall suitable for or configured to support an electrical connector of a connector-terminated electrical cable. As such, a “laterally inwards projecting” connector support extension may refer to a connector support extension, which extends towards a center, e.g., a center line, a center point, or central axis, of a side wall.

The connector support extension 437 of the embodiment of FIGS. 4 to 7 comprises a shoulder. In other embodiments, wherein a wiring support structure comprises a laterally inwards projecting connector support extension of a side wall, said connector support extension may comprise any suitable structure(s) or element(s), for example, a shoulder, a flange, a slit, a narrowed part, a perforated wall, a partially dividing wall, or the like.

In some embodiments, a wiring support structure may comprise one or more of the following: an electrical feedthrough, a cable gland, a cable clip, a cable clamp, and a cable tie mount. This is exemplified for an embodiment in an inset of FIG. 4, wherein a leg mounting insert 430 comprises a side wall 433, and a wiring support structure 436 comprises an electrical feedthrough 438. In the embodiment of the inset, the electrical feedthrough 438 may or may not be arranged at a distal end of the leg mounting insert 430.

In the embodiment of FIGS. 4 to 7, the leg mounting insert 430 comprises a proximal wiring space 435 proximal to the wiring support structure 436. The side wall 433 comprises an assembly opening 439, which extends into the proximal wiring space 435. Such assembly opening may facilitate securing electrical wiring, extending along a wiring pathway, to a side wall. Additionally or alternatively, such assembly opening may facilitate electrically coupling such electrical wiring to electrical devices, such as light sources. In other embodiments, a side wall may or may not comprise such assembly opening.

Herein, an “assembly opening” may refer to an opening in a side wall through which electrical wiring extending within a proximal wiring space may be manipulated or handled during assembly of a piece of furniture, e.g., a table.

In the embodiment of FIGS. 4 to 7, the assembly opening 439 extends along the side wall 433 to the distal end 432 of the leg mounting insert 430. The wiring pathway 411 extends from the assembly opening 439 at the distal end 432. Such assembly opening may further facilitate connecting electrical wiring, extending along a wiring pathway, to a side wall. In particular, such assembly opening may enable arranging electrical wiring, e.g., a connector-terminated electrical cable, along a wiring pathway using a simple lateral motion. In other embodiments, wherein a side wall comprises an assembly opening, said assembly opening may or may not extend along a side wall to a distal end, such that a wiring pathway extends from said assembly opening at said distal end.

In the embodiment of FIGS. 4 to 7, the side wall 433 has an outer surface 440. The outer surface 440 comprises a narrowed region 441 for holding a leg fastening collar, which may be, for example, in accordance with the leg fastening collar 200 of FIG. 2. In FIG. 4, positioning of such leg fastening collar is indicated using dotted lines.

The narrowed region 441 of the embodiment of FIGS. 4 surrounds the proximal wiring space 435. Such arrangement of a narrowed region and a proximal wiring space may facilitate reducing likelihood of electrical wiring, secured to a side wall, detaching and/or falling unintentionally. In particular, such arrangement may facilitate holding a leg fastening collar around a proximal wiring space such that an assembly opening is at least partially, i.e., partially or entirely, obstructed. In other embodiments, wherein a leg mounting insert comprises a proximal wiring space proximal to a wiring support structure, and a side wall comprises an assembly opening, extending into said proximal wiring space, and has an outer surface comprising a narrowed region for holding a leg fastening collar, said narrowed region may or may not surround said proximal wiring space.

In the embodiment of FIGS. 4 to 7, each of the first rail mount 421 and the second rail mount 422 comprises a tubular recess 426 configured to receive a pin fastener. Such tubular recess(es) in a connector may enable assembling a piece of furniture comprising a furniture frame with such connector in the absence of tools. Additionally or alternatively, such tubular recess(es) may increase a rigidity of such pieces of furniture. Additionally or alternatively, such tubular recess(es) may facilitate fabrication of a connector for a furniture frame for a piece of furniture, e.g., a table. In other embodiments, a first rail mount and/or a second rail mount may or may not comprise a tubular recess configured to receive a pin fastener.

Throughout this disclosure, a “pin fastener” may refer to a cylindrical element, such as a dowel pin, used to align and/or couple parts of a structure or a device. A pin fastener may generally have a diameter greater than or equal to 1 mm, 1.5 mm, or 2 mm and/or less than or equal to 20 mm, 15 mm, or 10 mm. Generally, such pin fastener may have a length greater than or equal to 3 mm, 4 mm, or 5 mm and/or less than or equal to 150 mm, 120 mm, or 100 mm. In some embodiments, a pin fastener may be fixed in place using an adhesive, such that sufficient clearance, for example, at least 0.25 mm may be provided around said pin fastener.

As such, a tubular recess or hole “configured to receive a pin fastener” may refer to a tubular recess or hole with a (smallest) diameter greater than or equal to 1 mm, 1.5 mm, or 2 mm and/or less than or equal to 20.5 mm, 15.5 mm, or 10.5 mm. Additionally or alternatively, a tubular recess or hole configured to receive a pin fastener may refer to a tubular recess or hole with a depth greater than or equal to 1.5 mm, 2 mm, or 2.5 mm and/or less than or equal to 100 mm, 75 mm, or 65 mm.

In the embodiment of FIGS. 4 to 7, the connector 400 has an exterior side 401. Each of the first rail mount 421 and the second rail mount 422 of the embodiment of FIGS. 4 to 7 comprises a rail end abutment surface 424 and a light block protrusion 425. Each of the light block protrusions 425 extends from the junction part 410 beyond its corresponding rail end abutment surface 424. The light block protrusions 425 are configured to hide the rail end abutment surfaces 424 from view from the exterior side 401 when the connector 400 is in use.

In the embodiment of FIGS. 4 to 7, the junction part 410, the first rail mount 421, the second rail mount 422, and the leg mounting insert 430 form a monolithic structure. Forming a junction part, a first rail mount, a second rail mount, and a leg mounting insert is such monolithic manner may increase a mechanical stability and/or rigidity of a connector. Additionally or alternatively, such monolithic structure may facilitate forming a connector using additive manufacturing methods, such 3D-printing, for example, (metal) binder jetting, powder bed fusion, or directed energy deposition. In other embodiments, a junction part, a first rail mount, a second rail mount, and a leg mounting insert may or may not form a monolithic structure.

Herein, a “monolithic” structure may refer to a structure formed of a single, seamless piece of material.

In the embodiment of FIGS. 4 to 7, the monolithic structure formed by the junction part 410, the first rail mount 421, the second rail mount 422, and the leg mounting insert 430 may comprise metal, for example, steel. Such material choice may generally impart increased rigidity to a connector. In other embodiments, wherein a junction part, a first rail mount, a second rail mount, and a leg mounting insert form a monolithic structure, said monolithic structure may or may not comprise metal.

For example, in some embodiments, such monolithic structure may comprise or consist (essentially) of plastic.

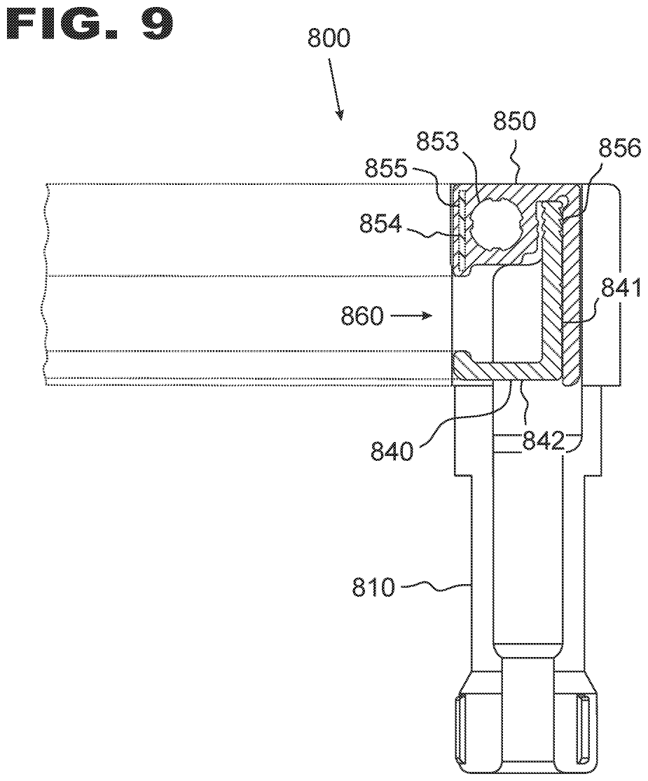

FIGS. 8 and 9 depict a furniture frame 800 for a piece of furniture, e.g., a table, according to an embodiment. FIG. 8 shows a top view of the furniture frame 800, whereas FIG. 9 illustrates a cross-sectional view of the furniture frame 800 along plane IX of FIG. 8. In other embodiments, a furniture frame 800 for a piece of furniture, e.g., a table, may be identical, similar, or different to the furniture frame 800 of the embodiment of FIGS. 8 and 9.

In the embodiment of FIGS. 8 and 9, the furniture frame 800 comprises a first connector 810, a second connector 820, and a frame rail 830 connecting the first connector 810 with the second connector 820. In FIG. 8, break lines are used to indicate that a part of the frame rail 830 is hidden for clarity.

In the embodiment of FIGS. 8 and 9, the frame rail 830 is coupled to each of the first connector 810 and the second connector 820. Each of the first connector 810 and the second connector 820 comprises a first rail mount 821 and a second rail mount 822, and the frame rail 830 is mounted to the first rail mount 821 of the first connector 810 and to the second rail mount 822 of the second connector 820.

In the embodiment of FIGS. 8 and 9, each of the first connector 810 and the second connector 820 may be a connector in accordance with the connector 400 of the embodiment of FIGS. 4 to 7. In other embodiments, a first connector and/or a second connector of a furniture frame may be connector in accordance with any connector disclosed within this specification, for example, in connection, with reference to, or concurrently with any of FIGS. 1 to 7.

In the embodiment of FIGS. 8 and 9, the furniture frame 800 comprises a single frame rail 830. As indicated schematically in FIGS. 8 and 9 using dashed lines, a furniture frame may generally comprise any suitable number, i.e., one or more, two or more, three or more, etc., of frame rails. Such frame rails may generally be coupled to any suitable number, i.e., two or more, three or more, four or more, etc., of connectors.

With reference to FIG. 9, the frame rail 830 of the embodiment of FIGS. 8 and 9 comprises a first structural profile 840 and a second structural profile 850 coupled with the first structural profile 840 such that a light guide support groove 860 is formed between the first structural profile 840 and the second structural profile 850. Such structure of a frame rail may enable supporting a light guide plate between a first structural profile and a second structural profile. In such case, a light source, e.g., a light-emitting diode (LED) source, may be arranged, for example, within a light guide support groove, such that light emitted by said light source is directed into said light guide plate through an edge face thereof. Additionally or alternatively, such structure of a frame rail may enable arranging a light guide plate between a first structural profile and a second structural profile in a removable and/or replaceable manner. In other embodiments, a frame rail may or may not comprise a first structural profile and a second structural profile coupled with said first structural profile such that a light guide support groove is formed between said first structural profile and said second structural profile.

In the embodiment of FIGS. 8 and 9, the first structural profile 840 comprises a first sheet part 841 and a second sheet part 842. The second sheet part 842 extends from the first sheet part 841 and at an angle with respect to the first sheet part 841. In other embodiments, a first structural profile may or may not comprise such first sheet part and such second sheet part.

The second structural profile 850 of the embodiment of FIGS. 8 and 9 comprises a fastening groove 856. The fastening groove 856 is configured to receive the first sheet part 841 in order to suspend the first structural profile 840 such that the light guide support groove 860 is formed between the second sheet part 842 and the second structural profile 850. Such arrangement of a first structural profile and a second structural profile may enable forming a snap-fit-type connection between said first structural profile and said second structural profile, which may facilitate forming a reliable and/or reversible coupling between said first structural profile and a second structural profile. Additionally or alternatively, such arrangement may simplify a structure of a frame rail. In other embodiments, wherein a frame rail comprises a first structural profile and a second structural profile coupled with the first structural profile, said second structural profile may or may not comprise a fastening groove, configured to receive a first sheet part of said first structural profile in order to suspend said first structural profile such that a light guide support groove is formed between a second sheet part of said first structural profile and said second structural profile.

In the embodiment of FIGS. 8 and 9, the second structural profile 850 has a first mounting end 851 and a second mounting end 852. The first mounting end 851 abuts a rail end abutment surface of the first rail mount 821 of the first connector 810, and the second mounting end 852 abuts a rail end abutment surface of the second rail mount 822 of the second connector 820.

The second structural profile 850 of the embodiment of FIGS. 8 and 9 comprises a tubular hole 853, configured to receive a pin fastener. The tubular hole 853 extends from the first mounting end 851 to the second mounting end 852, i.e., from both the first mounting end 851 and the second mounting end 852. Such tubular hole(s) in a second structural profile may enable assembling a piece of furniture in the absence of tools. Additionally or alternatively, such tubular hole(s) may increase rigidity of pieces of furniture. Additionally or alternatively, such tubular hole(s) may facilitate fabrication of a furniture frame for a piece of furniture, e.g., a table. In other embodiments, wherein a frame rail comprises a first structural profile and a second structural profile coupled with said first structural profile, said second structural profile may or may not comprise such tubular hole(s).

The first structural profile 840 and the second structural profile 850 of the embodiment of FIGS. 8 and 9 may comprise or be formed of aluminum (Al). Generally, usage of aluminum may allow forming a first structural profile and/or a second structural profile by extrusion.

Additionally or alternatively, such material choice may reduce a weight and/or increase a rigidity of a furniture frame. In other embodiments a first structural profile and/or a second structural profile may or may not comprise or be formed of aluminum.

As indicated in FIG. 9 using a dotted line, the second structural profile 850 of the embodiment of FIGS. 8 and 9 may comprise a tubular stiffener duct 854 between the first mounting end 851 and the second mounting end 852. The stiffener duct 854 may or may not extend from the first mounting end 851 to the second mounting end 852. The second structural profile 850 may further comprise a tubular reinforcement rod 855 fixed in the stiffener duct 854. Such stiffener duct(s) and reinforcement rod(s) may generally increase a rigidity of a furniture frame for a piece of furniture, e.g., a table. In other embodiments, wherein a frame rail comprises a first structural profile and a second structural profile, said second structural profile may or may not comprise a tubular stiffener duct between its first mounting end and its second mounting end and a tubular reinforcement rod fixed in said stiffener duct.

In the embodiment of FIGS. 8 and 9, the reinforcement rod 855 may comprise or be formed of steel. Such material choice may impart notably higher rigidity to a furniture frame for a piece of furniture, e.g., a table. In other embodiments, wherein a second structural profile comprises a tubular stiffener duct and a tubular reinforcement rod fixed in said stiffener duct, said reinforcement rod may or may not comprise steel. In said other embodiments, said second structural profile may or may not comprise aluminum.

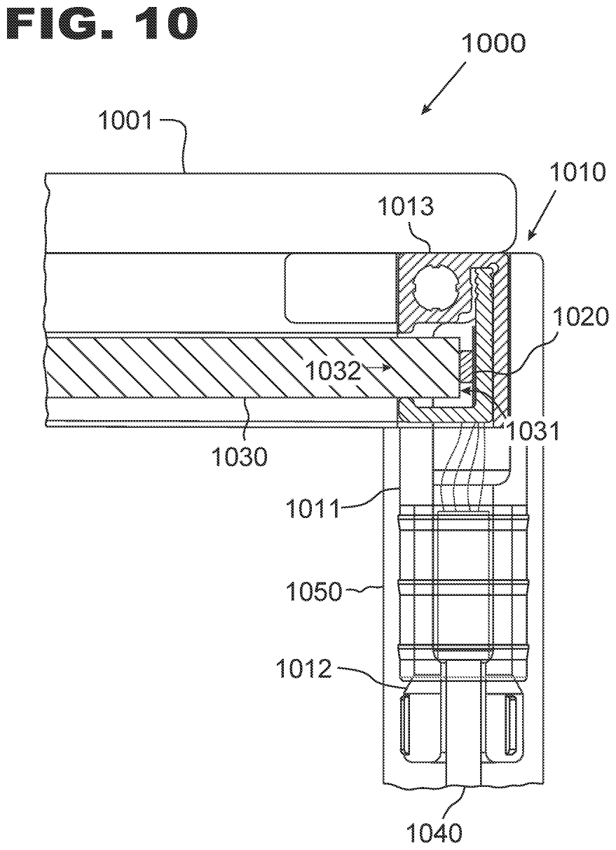

FIG. 10 depicts a cross-sectional view of a table 1000 according to an embodiment. The table 1000 of the embodiment of FIG. 10 serves as an example of a piece of furniture. In other embodiments, a piece of furniture, e.g., a table, a chair, a stool, a bench, a couch, a bed, a bookshelf, or a cabinet, may be identical, similar, or different to the table 1000 of the embodiment of FIG. 10

The table 1000 of the embodiment of FIG. 10 comprises a furniture frame 1010. The furniture frame 1010 of the embodiment of FIG. 10 may be, for example, in accordance with the furniture frame 800 of the embodiment of FIGS. 8 and 9. In other embodiments, a piece of furniture, e.g., a table, may comprise a furniture frame in accordance with any furniture frame disclosed within this specification.

The furniture frame 1010 of the embodiment comprises a first connector 1011 and a frame rail 1013 coupled to the first connector 1011. Although not explicitly shown in FIG. 10, the furniture frame 1010 may further comprise a second connector such that the frame rail 1013 connects the first connector 1011 with the second connector.

The table 1000 of the embodiment of FIG. 10 comprises a tabletop 1001, supported by the furniture frame 1010. In other embodiments, a piece of furniture, e.g., a table, may or may not comprise such tabletop.

In the embodiment of FIG. 10, at least part of the tabletop 1001 may be transparent or translucent. In other embodiments, wherein a piece of furniture, e.g., a table, comprises a tabletop, at least part of said tabletop may or may not be transparent or translucent.

The tabletop 1001 of the embodiment of FIG. 10 may have a rectangular, e.g., square, shape. In other embodiments, a tabletop may have any suitable regular or irregular shape, for example, a polygonal, e.g., triangular or quadrilateral, shape or a curvilinear, e.g., circular, elliptical, or oval, shape.

In the embodiment of FIG. 10, the table 1000 comprises a light source 1020, coupled to the furniture frame 1010. Addition of a light source into a piece of furniture, e.g., a table, may facilitate provision of sufficient levels of high-quality illumination, especially in case of strict space constraints. In other embodiments, a piece of furniture, e.g., a table, may or may not comprise a light source, coupled to a furniture frame.

The light source 1020 of the embodiment of FIG. 10 may be a light-emitting diode (LED) source, for example, a LED strip light or a LED light bar. In other embodiments, any suitable type of light source(s), such as LEDs source(s), for example, LED strip light(s) and/or LED light bar(s), may be used.

In the embodiment of FIG. 10, the table 1000 comprises a light guide plate 1030. The light guide plate 1030 has an edge face 1031. The light guide plate 1030 is supported by the furniture frame 1010 and arranged such that light emitted by the light source 1020 is directed into the light guide plate 1030 through the edge face 1031. Such arrangement of a light guide plate and a light source may enable redirecting light emitted by said light source upwards and/or downwards from said light guide plate. Additionally or alternatively, lighting with lower luminance and/or luminous emittance variations may be provided. In other embodiments, wherein a piece of furniture, e.g., a table, comprises a light source coupled to a furniture frame, said piece of furniture may or may not comprise a light guide plate with an edge face, said light guide plate being supported by said furniture frame and arranged such that light emitted by said light source is directed into said light guide plate through said edge face.

In the embodiment of FIG. 10, the light source 1020 of the embodiment of FIG. 10 is arranged into a light guide support groove 1032. Such arrangement of a light source may facilitate directing light emitted by said light source into a light guide plate. In other embodiments, a light source may or may not be arranged into a light guide support groove.

In the embodiment of FIG. 10, the first connector 1011 comprises a leg mounting insert 1012. The leg mounting insert 1012 is arranged into a hollow furniture leg 1050. The table 1000 comprises an electrical cable 1040, extending within leg mounting insert 1012, for supplying power to the light source 1020. Generally, arranging electrical wiring into a leg mounting insert of a connector may reduce obstruction for passage as well as simplify electrical wiring arrangements. In other embodiments, a piece of furniture, e.g., a table, may or may not comprise electrical wiring, e.g., an electrical cable, extending within a leg mounting insert, for supplying power to a light source.

It is to be understood that the embodiments of the first aspect described above may be used in combination with each other. Several of the embodiments may be combined together to form a further embodiment.

It is obvious to a person skilled in the art that with the advancement of technology, the basic idea of the invention may be implemented in various ways. The invention and its embodiments are thus not limited to the examples described above, instead they may vary within the scope of the claims.

It will be understood that any benefits and advantages described above may relate to one embodiment or may relate to several embodiments. The embodiments are not limited to those that solve any or all of the stated problems or those that have any or all of the stated benefits and advantages.

The term “comprising” is used in this specification to mean including the feature(s) or act(s) followed thereafter, without excluding the presence of one or more additional features or acts. It will further be understood that reference to ‘an’ item refers to one or more of those items.

REFERENCE SIGNS

| | |
|---|---|
| 100 | connector |
| 101 | exterior side |
| 110 | junction part |
| 111 | wiring pathway |
| 121 | first rail mount |
| 122 | second rail mount |
| 123 | mounting protrusion |
| 124 | rail end abutment surface |
| 125 | light block protrusion |
| 130 | leg mounting insert |
| 131 | proximal end |
| 132 | distal end |
| 133 | side wall |
| 140 | outer surface |
| 141 | narrowed region |
| 200 | leg fastening collar |
| 201 | shell |
| 202 | snap joint element |
| 203 | longitudinal gap |
| 300 | frame rail |
| 301 | mounting groove |
| 302 | light guide support groove |
| 400 | connector |
| 401 | exterior side |
| 410 | junction part |
| 411 | wiring pathway |
| 421 | first rail mount |
| 422 | second rail mount |
| 424 | rail end abutment surface |
| 425 | light block protrusion |
| 426 | tubular recess |
| 430 | leg mounting insert |
| 431 | proximal end |
| 432 | distal end |
| 433 | side wall |
| 435 | proximal wiring space |
| 436 | wiring support structure |
| 437 | connector support extension |
| 438 | electrical feed-through |
| 439 | assembly opening |
| 440 | outer surface |
| 441 | narrowed region |
| 800 | furniture frame |
| 810 | first connector |
| 820 | second connector |
| 821 | first rail mount |
| 822 | second rail mount |
| 830 | frame rail |
| 840 | first structural profile |
| 841 | first sheet part |
| 842 | second sheet part |
| 850 | second structural profile |
| 851 | first mounting end |
| 852 | second mounting end |
| 853 | tubular hole |
| 854 | stiffener duct |
| 855 | reinforcement rod |
| 856 | fastening groove |
| 860 | light guide support groove |
| 1000 | table |
| 1001 | tabletop |
| 1010 | furniture frame |
| 1011 | first connector |
| 1012 | leg mounting insert |
| 1013 | frame rail |
| 1020 | light source |
| 1030 | light guide plate |
| 1031 | edge face |
| 1032 | light guide support groove |
| 1040 | electrical cable |
| 1050 | furniture leg |

1. A furniture frame (800) for a piece of furniture, e.g., a table, comprising:
a first connector (810),
a second connector (820), and
a frame rail (830) connecting the first connector (810) with the second connector (820);
wherein the frame rail (830) comprises a first structural profile (840) and a second structural profile (850) coupled with the first structural profile (840) such that a light guide support groove (860) is formed between the first structural profile (840) and the second structural profile (850).

2. A furniture frame (800) according to claim 1, wherein the first structural profile (840) comprises a first sheet part (841) and a second sheet part (842), extending from and at an angle with respect to the first sheet part (841), and the second structural profile (850) comprises a fastening groove (856) configured to supportingly receive the first sheet part (841) such that the light guide support groove (860) is formed between the second sheet part (842) and the second structural profile (850).

3. A furniture frame (800) according to claim 1 or 2, wherein the second structural profile (850) has a first mounting end (851) as well as a second mounting end (852) and comprises a tubular hole (853), e.g., a slot or a through-hole, extending from the first mounting end (851) and/or the second mounting end (852), the tubular hole (853) being configured to receive a pin fastener.

4. A furniture frame (800) according to any of the preceding claims, wherein the first structural profile (840) and/or the second structural profile (850) comprises aluminum.

5. A furniture frame (800) according to any of the preceding claims, wherein the second structural profile (850) comprises a tubular stiffener duct (854) between the first mounting end (851) and the second mounting end (852) and a tubular reinforcement rod (855) fixed in the stiffener duct (854).

6. A furniture frame (800) according to claim 5, wherein the reinforcement rod (855) comprises steel.

7. A furniture frame (800) according to any of the preceding claims, wherein the first connector (810) and/or the second connector (820) is a connector (100) in accordance with any of claims 11 to 21.

8. A piece of furniture, e.g., a table (1000), comprising a furniture frame (1010) in accordance with any of claims 1 to 7.

9. A piece of furniture according to claim 8, comprising a light source (1020), e.g., a light-emitting diode source, coupled to the furniture frame (1010).

10. A piece of furniture according to claim 9, the piece of furniture comprises a light guide plate (1030) supported by the furniture frame (1010) and arranged such that light emitted by the light source (1020) is directed into the light guide plate (1030) through an edge face (1031) thereof.

11. A connector (100) for a furniture frame for a piece of furniture, e.g., a table, comprising:
a junction part (110);
a first rail mount (121) coupled with the junction part (110);
a second rail mount (122) coupled with the junction part (110); and
a tubular leg mounting insert (130) configured to be inserted into a hollow furniture leg, the leg mounting insert (130) having a proximal end (131) towards the junction part (110) and a distal end (132) opposite the proximal end (131) and comprising a side wall (133), extending from the junction part (110) to the distal end (132);
wherein a wiring pathway (111) extends from the distal end (132) to the proximal end (131) within the leg mounting insert (130) and from the proximal end (131) further to each of the first rail mount (121) and the second rail mount (122) within the junction part (110).

12. A connector (100) according to claim 11, wherein the leg mounting insert (430) comprises a wiring support structure (436) for securing electrical wiring, extending along the wiring pathway (411), to the side wall (433).

13. A connector (400) according to claim 12, wherein the wiring support structure (436) comprises a laterally inwards projecting connector support extension (437) of the side wall (433).

14. A connector (400) according to claim 12 or 13, wherein the wiring support structure (436) comprises at least one of the following: an electrical feedthrough (438), a cable gland, a cable clip, a cable clamp, and a cable tie mount.

15. A connector (400) according to any of claims 12 to 14, wherein the leg mounting insert (430) comprises a proximal wiring space (435) proximal to the wiring support structure (436), and the side wall (433) comprises an assembly opening (439), extending into the proximal wiring space (435).

16. A connector (400) according to claim 15, wherein the assembly opening (439) extends along the side wall (433) to the distal end (432), the wiring pathway (411) extending from the assembly opening (439) at the distal end (432).

17. A connector (100) according to any of claims 11 to 16, wherein the side wall (133) has an outer surface (140) comprising a narrowed region (141) for holding a leg fastening collar (200).

18. A connector (100) according to any of claims 11 to 17, wherein the first rail mount (121) and/or the second rail mount (122) comprises a mounting protrusion (123) for supporting a frame rail (300).

19. A connector (400) according to any of claims 11 to 18, wherein the first rail mount (421) and/or the second rail mount (422) comprises a tubular recess (426) configured to receive a pin fastener.

20. A connector (100) according to any of claims 11 to 19, wherein the connector (100) has an exterior side (101), and the first rail mount (121) and/or the second rail mount (122) comprises a rail end abutment surface (124) and a light block protrusion (125) extending from the junction part (110) beyond the rail end abutment surface (124), the light block protrusion (125) being configured to hide the rail end abutment surface (124) from view from the exterior side (101), when the connector (100) is in use.

21. A connector (400) according to any of claims 11 to 20, wherein the junction part (410), the first rail mount (421), the second rail mount (422), and the leg mounting insert (430) form a monolithic structure.

22. A furniture frame (800) for a piece of furniture, e.g., a table, comprising a first connector (810), a second connector (820), and a frame rail (830) connecting the first connector (810) with the second connector (820), wherein the first connector (810) and/or the second connector (820) is a connector (100) in accordance with any of claims 11 to 21.

23. A furniture frame (800) according to claim 22, wherein the frame rail (830) comprises a first structural profile (840) and a second structural profile (850) coupled with the first structural profile (840) such that a light guide support groove (860) is formed between the first structural profile (840) and the second structural profile (850).

24. A piece of furniture, e.g., a table (1000), comprising a furniture frame (1010) in accordance with claim 22 or 23.

25. A piece of furniture according to claim 24, comprising a light source (1020), e.g., a light-emitting diode source, coupled to the furniture frame (1010).

26. A piece of furniture according to claim 25, comprising a light guide plate (1030), having an edge face (1031), the light guide plate (1030) being supported by the furniture frame (1010) and arranged such that light emitted by the light source (1020) is directed into the light guide plate (1030) through the edge face (1031).

27. A piece of furniture according to claim 25 or 26, comprising electrical wiring, e.g., an electrical cable (1040), extending within a leg mounting insert (1012), for supplying power to the light source (1020).
